(19) United States
(12) Patent Application Publication
(10) Pub. No.: US 2023/0377441 A1
(43) Pub. Date: Nov. 23, 2023

(54) SYSTEM AND METHOD FOR PROVIDING THERMAL ALERTS IN A DEVICE

(71) Applicant: LENOVO ENTERPRISE SOLUTIONS (SINGAPORE) PTE LTD., SINGAPORE (SG)

(72) Inventors: JAMES G. MCLEAN, MORRISVILLE, NC (US); GARY D. CUDAK, MORRISVILLE, NC (US); ISRAEL SILVA DIAS, APEX, NC (US)

(21) Appl. No.: 17/750,049

(22) Filed: May 20, 2022

(51) Int. Cl. G08B 21/18

(52) U.S. Cl. CPC G08B 21/182

(57) ABSTRACT

Providing a thermal alert to a user includes receiving an event in a wearable device with a thermal element, and upon receiving the event in the wearable device, providing the thermal alert by the wearable device via the thermal element to the user, where the thermal alert includes a pattern associated with an event type.

### BACKGROUND

Wearable devices include smart devices or communicate with smart devices and provide signals to users. Wearable devices are devices in contact with or in close proximity to a user and include devices such as a ring, pin, wristband or armband, fitness tracker, body-mounted strap or patch, smart clothing or blanket, a headset, smart glasses, smart headphones, or other wearable device. The wearable device may be a smart device or may be in wired or wireless communication with a smart device, such as a smartphone or laptop. The wearable device provides a signal that may be a notification or alert. The signal may be visual, such as flashing a color on a screen or flashing an indicator light, or may be audible, such as a noise or song, or may be haptic, such as vibrating. These signals are visibly or audibly apparent to other users. A silent and unobtrusive signal that is undetected by others is desired.

### BRIEF SUMMARY

Methods, systems, and apparatus for providing a thermal alert to a user are disclosed in this specification. Providing a thermal alert to a user includes receiving an event in a wearable device with a thermal element; and upon receiving the event in the wearable device, providing the thermal alert by the wearable device via the thermal element to the user, wherein the thermal alert is a specific pattern in order to appropriately convey the event.

The foregoing and other objects, features and advantages of the present disclosure will be apparent from the following more particular descriptions of exemplary embodiments of the present disclosure as illustrated in the accompanying drawings wherein like reference numbers generally represent like parts of exemplary embodiments of the present disclosure.

### BRIEF DESCRIPTION OF THE DRAWINGS

FIG. 1A sets forth a block diagram of an example system configured for providing a thermal alert to a user according to embodiments of the present disclosure.

FIG. 1B sets forth a block diagram of another example system configured for providing a thermal alert to a user according to embodiments of the present disclosure.

FIG. 1C sets forth a block diagram of another example system configured for providing a thermal alert to a user according to embodiments of the present disclosure.

FIG. 2 sets forth a flow chart illustrating an exemplary method for providing a thermal alert to a user according to embodiments of the present disclosure.

FIG. 3 sets forth a flow chart illustrating another exemplary method for providing a thermal alert to a user according to embodiments of the present disclosure.

### DETAILED DESCRIPTION

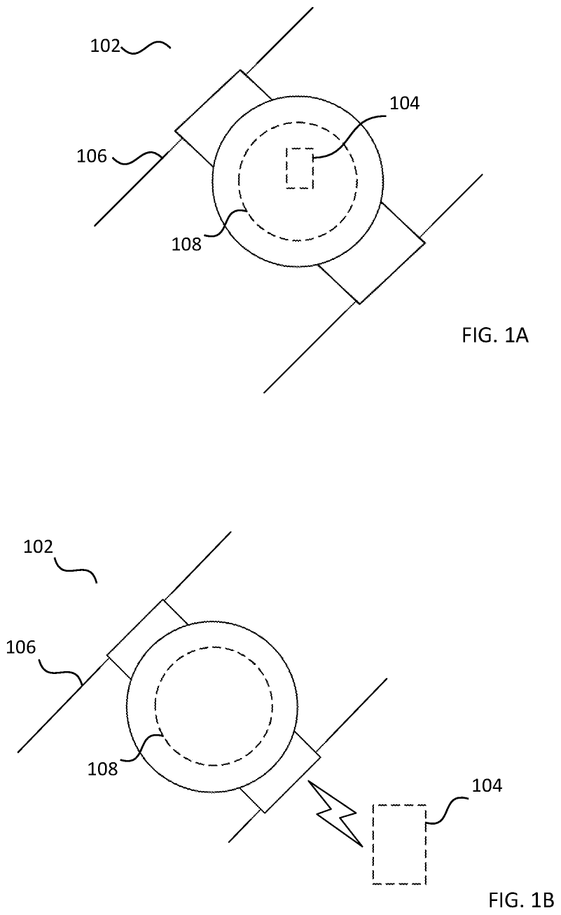

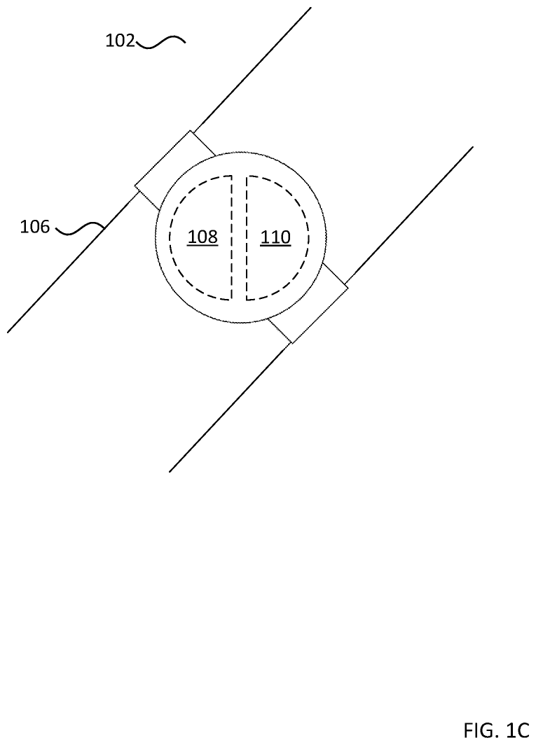

Exemplary methods, apparatus, and products for providing a thermal alert to a user in accordance with the present disclosure are described with reference to the accompanying drawings, beginning with FIG. 1A. FIG. 1A sets forth a diagram of a wearable device 102 configured for providing a thermal alert to a user according to embodiments of the present disclosure. The wearable device 102 of FIG. 1A includes a thermal element 108 and a smart computer 104. The wearable device 102 of FIG. 1A is shown as a wristwatch device. The wearable device 102 may be any type of wearable device, such as a ring, pin, wristband or armband, fitness tracker, body-mounted strap or patch, smart clothing or blanket, or a headset that may include smart glasses or smart headphones or both, or other wearable device.

The wearable device 102 includes hardware and software that communicates and controls thermal element 108. Thermal element 108 may be an element that provides heat or provides cold or both. In some embodiments, thermal element 108 may provide heat by a resistor and a switch or by routing waste heat in a controlled manner or by another method to provide controlled heat. In some embodiments, thermal element 108 may be a Peltier device that provides cold. In some embodiments, thermal element 108 may provide both heat and cold for different signals, including different patterns of hot and cold to present different notifications, where each pattern is associated with a different event type. thermal element 108 is in contact with user 106, either directly contacting the skin of user 106 or being near to the skin of user 106.

The smart computer 104 controls thermal element 108 in the wearable device 102. More specifically, the smart computer 104 monitors events and upon receiving an event, controls thermal element 108 to signal the user 106. Events include notifications of new emails or texts or incoming phone calls or notifications from a calendar application or other application that may be configured remotely or that the user 106 sets.

In FIG. 1B, the wearable device 102 is in communication with smart computer 104. The wearable device 102 may be in wired communication with smart computer 104 or wireless communication with smart computer 104, such as via Bluetooth communications. The smart computer 104 may be a smartphone device or may be a tablet, laptop, computer, or other smart device. The smart computer 104 controls thermal element 108 in the wearable device 102. More specifically, the smart computer 104 monitors events and upon receiving an event, controls thermal element 108 to signal the user 106. Events include notifications of new emails or texts or incoming phone calls or notifications from a calendar application or other application that the user 106 sets. Specific notifications (notifications of different event types) have different predefined patterns of hot or cold for varying periods of time. Different event types are signaled with multiple predefined patterns of thermal notifications of differing duration/temperatures.

In FIG. 1C, the wearable device 102 includes multiple thermal element 108 and 110. While two thermal elements are shown in FIG. 1C, it should be understood that more thermal elements are contemplated, including three or four or more thermal elements or thermal elements on additional wearable devices such as a headset or ring or other additional wearable device. When the wearable device 102 or an additional wearable device has multiple thermal elements 108 and 110, then the thermal elements can be programmed by the smart computer (not shown) to signal simultaneously or in patterns or different thermal elements for different notifications. Similarly, each wearable device, with one or more thermal elements, may be controlled in coordination by smart computers located internal or external to the wearable device.

For further explanation, the smart computer 104 configured for providing a thermal alert to a user according to embodiments of the present disclosure is described in more detail. The smart computer 104 includes include a processor, memory, network controller, and storage drive in various configurations (not shown). The smart computer 104 controls the wearable device 102, located either internally in the wearable device 102 as shown in FIG. 1A or located externally to the wearable device 102 as shown in FIG. 1B and connected wired or wirelessly such as by Bluetooth or other wireless communication protocol. The smart computer 104 controls the thermal element 108 of FIG. 1A and FIG. 1B and the thermal element 108 and 110 of FIG. 1C, including additional thermal elements located on the wearable device 102 or on an additional wearable device or devices.

The smart computer 104 runs applications that are programmed and configured remotely and by the user 106. Examples of the applications include email, phone, a calendar application, an alarm or alarms, a timer, an application that generates push notifications, or other applications that may be remotely or locally configured. When the application generates an event, an alert or notification, then the smart computer 104 controls the thermal element 108 of FIG. 1A and FIG. 1B and the thermal element 108 and 110 of FIG. 1C to signal the user 106. The thermal element 108 of FIG. 1A and FIG. 1B and the thermal elements 108 and 110 of FIG. 1C can be configured to signal the user 106 with a single pulse or a continuous signal of heat or cold or with a pattern of heat or cold or both in order to appropriately convey the specific notification. Specific notifications have different predefined patterns of hot or cold for varying periods of time. Different events are signaled with multiple predefined patterns of thermal notifications of differing duration/temperatures. Different events trigger different thermal signals from the thermal element 108 of FIG. 1A and FIG. 1B and the thermal elements 108 and 110 of FIG. 1C, including additional thermal elements located on the wearable device 102 or on an additional wearable device or devices.

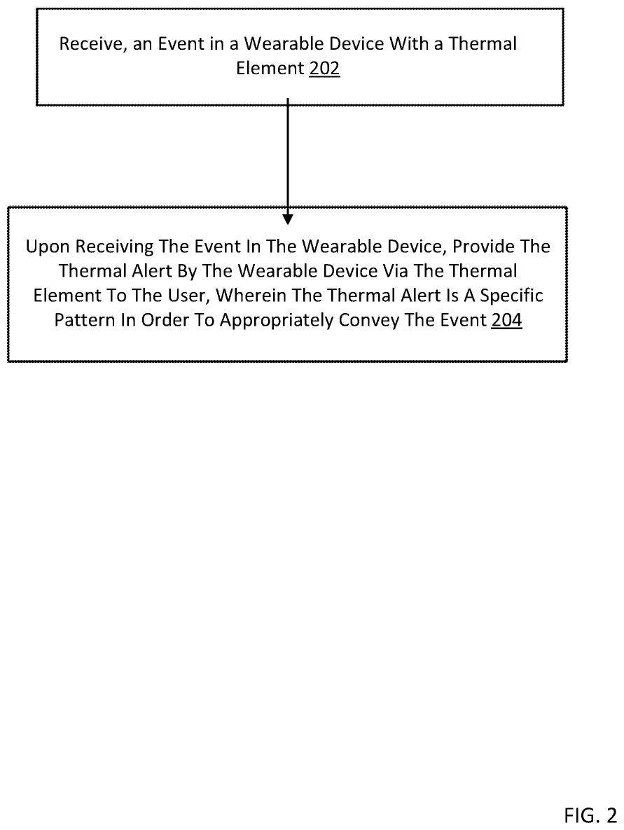

For further explanation, FIG. 2 sets forth a flow chart illustrating an exemplary method for providing a thermal alert to a user according to embodiments of the present disclosure that includes receiving 202 an event in a wearable device with a thermal element. Receiving 202 an event in a wearable device with a thermal element includes the smart computer receiving an event from a locally or remotely configured application. For example, the smart computer receives an event, which can be an alert or a push notification, from email, phone, a calendar application, an alarm or alarms, a timer, an application that generates push notifications, or another application that may be remotely or locally configured.

As described above, the smart computer may be located either internally in the wearable device as shown in FIG. 1A or located externally to the wearable device as shown in FIG. 1B and connected wired or wirelessly such as by Bluetooth or other wireless communication protocol.

FIG. 2 also includes upon receiving the event in the wearable device, providing 204 the thermal alert by the wearable device via the thermal element to the user, wherein the thermal alert is a specific pattern in order to appropriately convey the event. Upon receiving the event in the wearable device, providing 204 the thermal alert by the wearable device via the thermal element to the user, wherein the thermal alert is a specific pattern in order to appropriately convey the event, includes the smart computer receiving an event and providing a thermal alert by controlling the thermal element in the wearable device. For example, the smart computer controls the thermal element of FIG. 1A and FIG. 1B. The thermal element of FIG. 1A and FIG. 1B can be configured to signal the user with a single pulse or a continuous signal of heat or cold or with a pattern of heat or cold or both in order to appropriately convey the specific notification. Different event types trigger different thermal signals from the thermal element. Specific notifications have different predefined patterns of hot or cold for varying periods of time. Different events are signaled with predefined patterns of multiple thermal notifications of differing duration/temperatures.

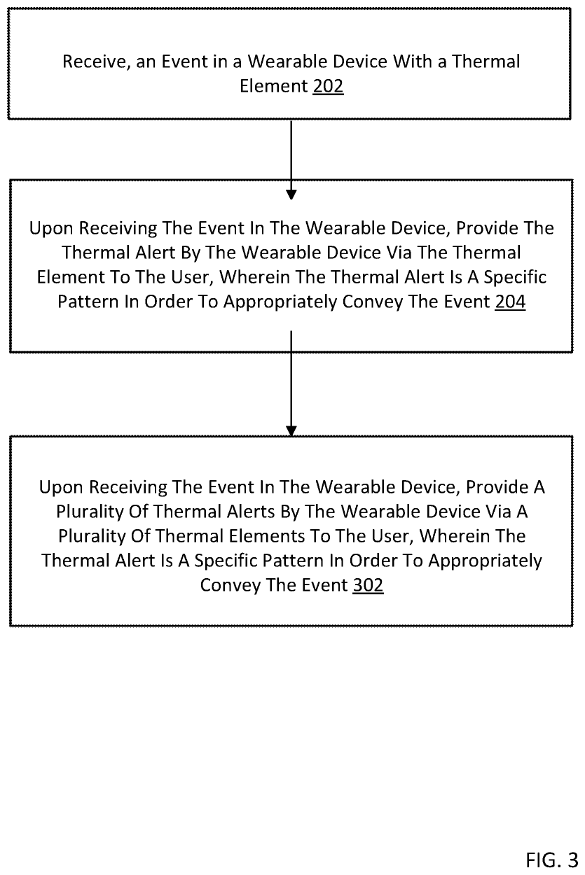

For further explanation, FIG. 3 sets forth a flow chart illustrating an exemplary method for providing a thermal alert to a user according to embodiments of the present disclosure. The method of FIG. 3 includes receiving 202 an event in a wearable device with a thermal element; and upon receiving the event in the wearable device, providing 204 the thermal alert by the wearable device via the thermal element to the user.

The method of FIG. 3 differs from the method of FIG. 2, in that FIG. 3 includes upon receiving the event in the wearable device, providing 302 a plurality of thermal alerts by the wearable device via a plurality of thermal elements to the user, wherein the thermal alert is a specific pattern in order to appropriately convey the event. Upon receiving the event in the wearable device, providing 302 a plurality of thermal alerts by the wearable device via a plurality of thermal elements to the user, wherein the thermal alert is a specific pattern in order to appropriately convey the event, includes the smart computer receiving an event and providing a thermal alert by controlling the thermal elements in the wearable device. For example, the smart computer controls the thermal elements of FIG. 1C, including additional thermal elements located on the wearable device 102 or on an additional wearable device or devices. The thermal elements of FIG. 1C, including additional thermal elements located on the wearable device 102 or on an additional wearable device or devices, can be configured to signal the user 106 with a single pulse or a continuous signal of heat or cold or with a pattern of heat or cold or both in order to appropriately convey the specific notification. Different event types trigger different thermal signals from the thermal elements of FIG. 1C, including additional thermal elements located on the wearable device 102 or on an additional wearable device or devices. Specific notifications have different predefined patterns of hot or cold for varying periods of time. Different events are signaled with different predefined patterns of thermal notifications of differing duration/temperatures.

In view of the explanations set forth above, readers will recognize that the benefits of providing a thermal alert to a user according to embodiments of the present disclosure include:
Providing an invisible, inaudible thermal signal to a user
Providing specific thermal signals for specific notifications to a user
Providing a discreet, unobtrusive thermal alert to a user

1. A method for providing a thermal alert to a user, the method comprising:
receiving an event in a wearable device, the wearable device including multiple thermal elements; and
upon receiving the event in the wearable device, providing the thermal alert by the wearable device via one or more of the multiple thermal elements to the user, wherein the thermal alert comprises a pattern associated with an event type, and wherein each thermal element is configured to provide thermal alerts corresponding to different event types.

2. The method of claim 1 wherein the wearable device includes a smart computer located external to the wearable device in communication with the wearable device.

3. The method of claim 1 wherein the wearable device includes a smart computer located internal to the wearable device.

4. The method of claim 1 wherein the thermal alert is heat.

5. The method of claim 1 wherein the thermal alert is cold.

6. An apparatus for providing a thermal alert to a user, the apparatus comprising:
a wearable device configured to receive an event; and
a plurality of thermal elements located on the wearable device and configured to provide the thermal alert to the user in response to the wearable device receiving the event, wherein the thermal alert is a specific pattern in order to appropriately convey the event, and wherein each of the plurality of thermal elements is configured to provide thermal alerts corresponding to different event types.

7. The apparatus of claim 6, further comprising:
a smart computer located external to the wearable device in communication with the wearable device.

8. The apparatus of claim 6, further comprising:
a smart computer located internal to the wearable device.

9. The apparatus of claim 6 wherein the thermal alert is heat.

10. The apparatus of claim 6 wherein the thermal alert is cold.

11. The apparatus of claim 6, wherein the plurality of thermal elements are configured to provide a plurality of thermal alerts to the user in response to the wearable device receiving multiple events having different event types.

12. The apparatus of claim 6, further comprising:
an additional wearable device configured to receive the event; and
a thermal element located on the additional wearable device and configured to provide the thermal alert to the user in response to the additional wearable device receiving the event.

13. A computer program product for providing a thermal alert to a user, the computer program product comprising a non-volatile computer readable medium and computer program instructions stored therein that are configured to, when executed, cause a computer to carry out the steps of:
receiving an event in a wearable device, the wearable device including multiple thermal elements; and
upon receiving the event in the wearable device, providing the thermal alert by the wearable device via one or more of the multiple thermal elements to the user, wherein the thermal alert is a specific pattern in order to appropriately convey the event, and wherein each thermal element is configured to provide thermal alerts corresponding to different event types.

14. The computer program product of claim 13 wherein the wearable device includes a smart computer located external to the wearable device in communication with the wearable device.

15. The computer program product of claim 13 wherein the wearable device includes a smart computer located internal to the wearable device.

16. The computer program product of claim 13 wherein the thermal alert is one of heat and cold.

17. The computer program product of claim 13, further comprising:
upon receiving the event in the wearable device, providing a plurality of thermal alerts by the wearable device via a plurality of thermal elements to the user.

18. The computer program product of claim 13 wherein the computer readable medium comprises a storage medium.

19. A method of providing a thermal alert to a user, the method comprising:
receiving an event in a wearable device; and
providing a plurality of thermal alerts by the wearable device via a plurality of thermal elements to the user, wherein each of the plurality of thermal elements is configured to provide thermal alerts corresponding to different event types.

20. The method of claim 19 wherein providing the plurality of thermal alerts further comprises providing the thermal alerts via one or more additional wearable devices, each wearable device comprising one or more thermal elements.
